(19) United States
(12) Patent Application Publication
(10) Pub. No.: US 2016/0162648 A1
(43) Pub. Date: Jun. 9, 2016

(54) Method for Creating Standardized Patient Care Pathways

(71) Applicant: Julia Richards van Zyl, Knoxville, TN (US)

(72) Inventor: Julia Richards van Zyl, Knoxville, TN (US)

(21) Appl. No.: 14/958,164

(22) Filed: Dec. 3, 2015

Related U.S. Application Data
(60) Provisional application No. 62/087,059, filed on Dec. 3, 2014.

(51) Int. Cl. G06F 19/00

(52) U.S. Cl. CPC G06F 19/327; G06F 19/324

(57) ABSTRACT

A method and process for devising and designing standardized patient care pathways, gaining approval for such patient care pathways, communicating such standardized patient care pathways to relevant healthcare providers and educating such healthcare providers as to the standardized patient care pathway, and implementing and monitoring such standardized patient care pathways.

### CROSS-REFERENCE TO RELATED APPLICATIONS

This application claims the benefit of U.S. Provisional Patent Application No. 62/087,059, filed on Dec. 3, 2014, which is incorporated herein in its entirety by reference.

### STATEMENT REGARDING FEDERALLY SPONSORED RESEARCH OR DEVELOPMENT

Not Applicable

### BACKGROUND OF THE INVENTION

1. Field of Invention

The invention relates to a patient care system. More particularly, it relates to a method for creating standardized patient care pathways.

2. Description of the Related Art

In the healthcare arts, and specifically patient and family centered healthcare arts, it is known to organize patient care, or workflow, in a hospital environment in a manner that includes information concerning the latest care and practice standards.

What is missing from the art is a method for standardizing healthcare plans via patient care pathways. Accordingly, it is an object of the present invention to create standardized healthcare plans via Patient Care Pathways, using evidence based tools and a collaborative design approach, that will improve patient outcomes (reduce LOS, readmission rates, morbidity, mortality and hospital acquired complications); increase provider efficiency and communication; improve patient, family, and provider satisfaction; achieve quality and regulatory demands; and decrease healthcare cost. Included within the overall method are methods for developing and approving standardized patient care pathways, as well as for managing communications concerning patient specific deviations from a standardized patient care pathway. Using these methods (principles), will allow healthcare providers to provide a consistent foundation for educating current and future staff and residents and become a beacon for evidence based care in the future.

### BRIEF SUMMARY OF THE INVENTION

The present general inventive concept includes processes for devising and designing standardized patient care pathways, gaining approval for such patient care pathways, communicating such standardized patient care pathways to relevant healthcare providers and educating such healthcare providers as to the standardized patient care pathway, and implementing and monitoring such standardized patient care pathways.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a flow diagram of an exemplary patient care procedural pathway;

FIG. 2 is a flow diagram of a combined general medicine and disease specific patient care pathway;

FIGS. 3A and 3B are a flow diagram of the general medicine patient care pathway showing the addition of a disease specific snap-on;

FIG. 4 is a flow diagram of a general medicine patient care pathway;

FIGS. 5A and 5B are a flow diagram illustrating the process for selection of multidisciplinary team members to attend rapid pathway design;

FIGS. 6A and 6B are a flow diagram of an exemplary schedule for a multi-day rapid pathway design conference;

FIGS. 7A and 7B are a flow diagram illustrating an exemplary process for approval of a proposed patient care pathway by a pathway order set committee;

FIGS. 8A and 8B are a flow diagram illustrating exemplary process for pathway compliance metrics; and

FIGS. 9A, 9B, 9C, and 9D are a flow diagram illustrating an exemplary process for developing and approving both major and minor revisions to a patient care pathway.

### DETAILED DESCRIPTION OF THE INVENTION

In accordance with the concepts of the present general invention and to understand the present description, the following definitions apply:—An entity that can be affected by the results of a pathway; Medical Director—Medical Director of Patient Care Pathways; PFC—Pathway Facilitation Coordinator; POSC—Pathway Order Set Committee; RD event—Rapid Design Event; RDW—Rapid Design Week; POT—Project Operational Team Meeting; COEE—Centers of Excellence Equivalent; Pathway Champion—Individual deemed as a leader of the pathway; in an exemplary embodiment, patient care pathways will contain a Physician Champion, Nurse Champion and a Pharmacy Champion; PreSearch—The research done regarding a specific pathway prior to the Rapid Design Event; ProVation—Evidence Based Support Tool; PASAT—Pathways Ancillary Service Advisory Team; Pathway Architecture Team—Medical Director, and Pathway Facilitation Coordinator; and the BUILD TEAM—Clinical and pharmacy analysts that build the pathways using a data processing system, which may include computer hardware and software.

### Pathway Concepts

### What is a Patient Care Pathway?

Patient Care Pathway: As used herein, the phrase “Patient Care Pathway” denotes a patient-centered, evidence-based care plan developed through a multi-disciplinary collaborative process, containing milestones that communicate and standardize the care of the patient across the entire healthcare continuum.

A pathway consists of both general admission components and disease specific components that are arranged according to approved architectural guidelines. Pathway standards of care may also be contained within the pathway or snapped on to allow complete care of the patient.

### What is an Adjunct Pathway?

Adjunct Pathway: Standardized, evidence based management plans that apply to common symptoms, therapeutic interventions or processes that can apply to all patients, regardless of disease state.

Examples of such pathways of standardized care include: Unit standards, pain management plans, complex drip protocols, common bedside procedures, DVT prophylaxis, and tobacco cessation, or other detoxification, plans. Pathway care plans are developed under the same guidelines as pathways.

General Admission Pathway: A set of non-disease specific orders that pertain to the admission of all patients. The bed request, generic admission studies, and regulatory requirements are bundled here. These common orders are bundled together to avoid duplication when multiple disease specific snap-ons are required to complete the continuum of care for the patient.

Disease Specific Pathway with General Admission: A bundled set of orders that outline the care for a specific disease state. General admission components are included with these pathways.

Disease Specific Pathway Snap-On: Snap-ons are stand-alone disease specific pathways that are designed to minimize redundant orders so that multiple disease states can be addressed for a given patient.

Symptom Based Pathway: These pathways are designed based on symptoms when a clear etiology of disease has not yet been established.

Rapid Pathway Design: Methodology by which Patient Care Pathways are developed in a time and resource efficient manner.

Rapid Pathway Design Week: in accordance with an exemplary embodiment, a 3-5 day-long event that is held for a multidisciplinary healthcare team (stakeholders) to collaborate and discuss a specific disease state. Clinical and process content are reviewed and discussed. The deliverable from this week is the content for a Patient Care Pathway.

Milestones: Key markers in the delivery of the care of the patient that identify progression to wellness. Milestones are identified for each pathway and help educate the patient, family and healthcare providers what the goals of the healthcare plan are. Milestones are listed at the beginning of each pathway.

### Pathway Guiding Principles

Patient Care Pathways are designed using the following guiding principles: Consideration of course of care that is best for the patient, improve the quality of care delivered to a care facility's patients; facilitate all providers' ability to deliver safe, quality care to the patient in an efficient manner; achieve organizational strategic objectives; comply with regulatory standards and quality measures.

Further, in an exemplary embodiment, the following considerations serve as guidelines in developing a patient care pathway: the treatment that is in the patient's best interest, i.e. what is best for the patient? (VSM); consideration of the workflow of all healthcare providers; meeting all organizational strategic objectives; meeting all regulatory standards and quality measures; consideration of avoidance of hospital acquired complications; patient and family satisfaction with regard to quality of attention and care; health care provider satisfaction; the healthcare continuum; education of the patient regarding their disease process, expectations and prognosis; early consideration of palliative care; the selection of a transitional plan of care has been considered, and effective communication of that transitional plan to the next care giver/provider, especially if that care giver is the patient herself.

### Pathway Architectural Guidelines

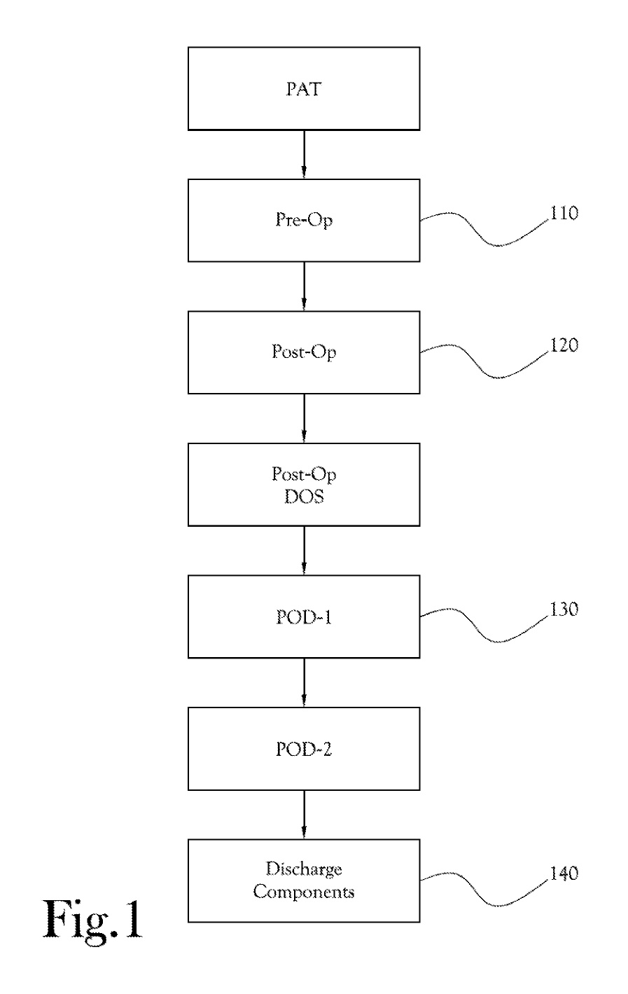

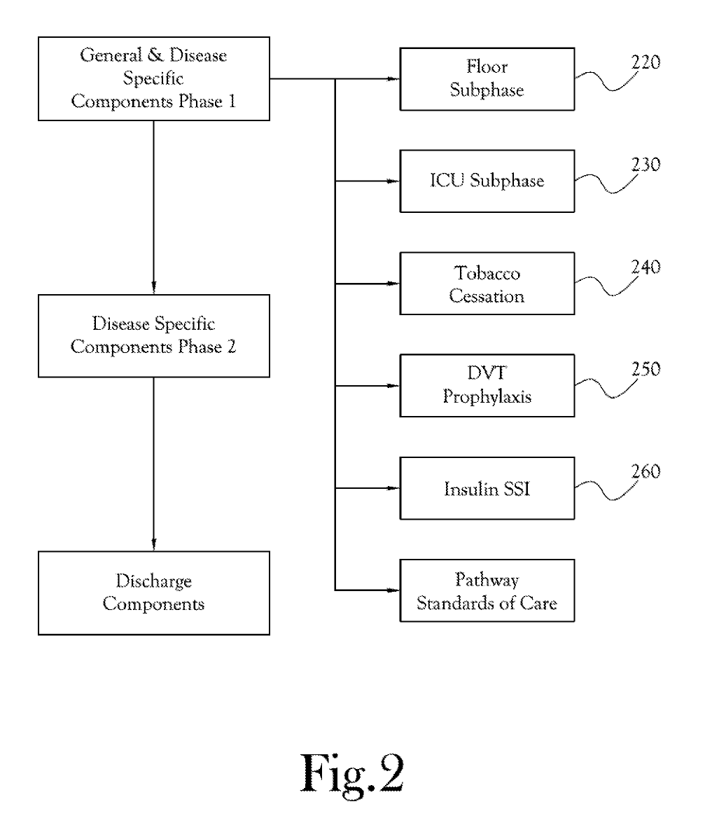

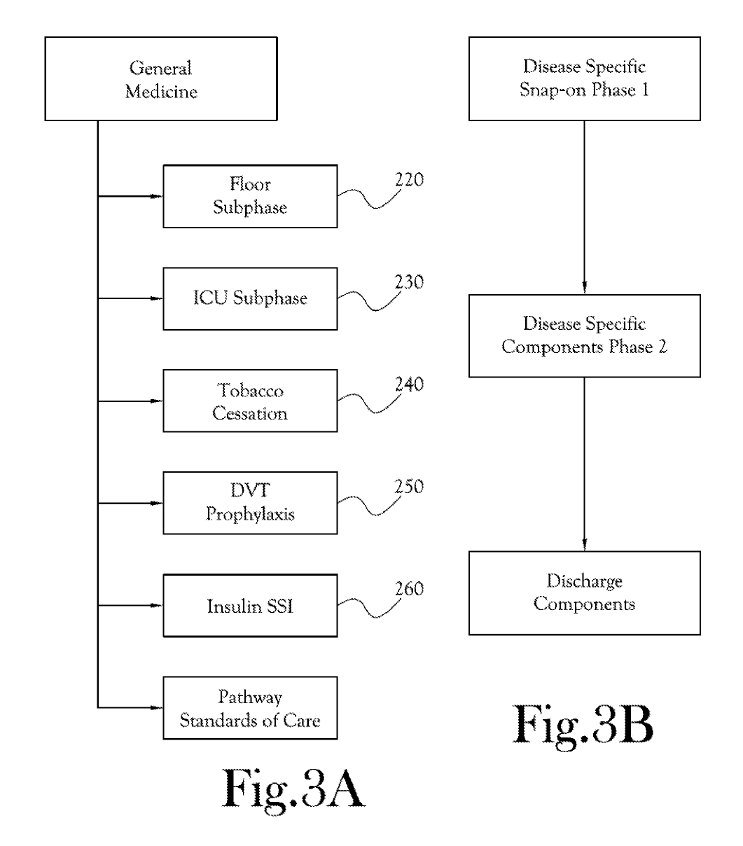

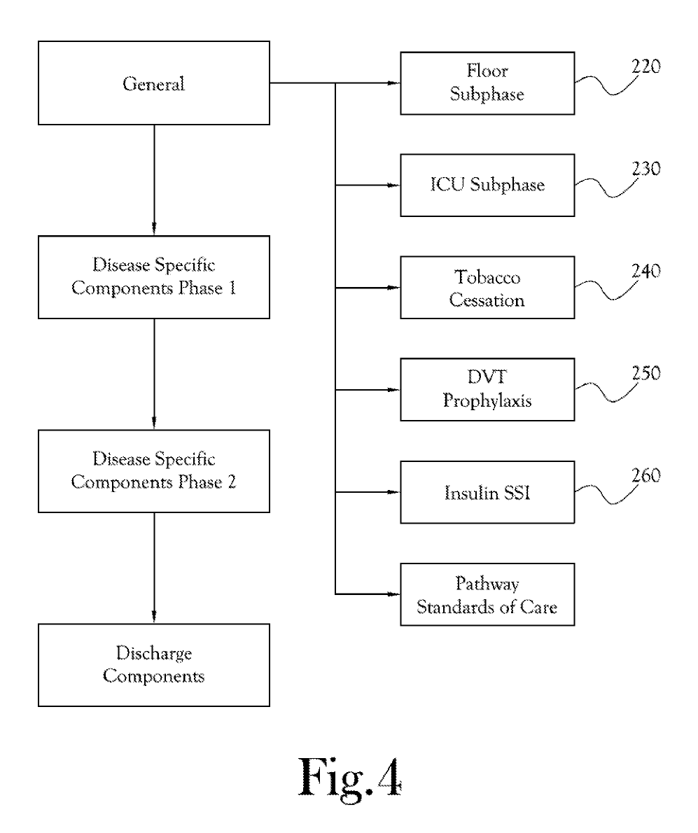

Referring to FIG. 1, a pathway, in accordance with an exemplary embodiment, will contain general admission components, disease specific components and may contain applicable adjunct pathways, such as pre-operative, (“pre-op”), standards 110, post-op standards 120, standards of care for post-operative days 130, and standards of care concerning discharge 140, just to name a few. As seen in FIGS. 2, 3A, 3B, and 4, exemplary patient care pathways can combine general medicine standards of care and disease specific standards of care, and can include subphases for specific issues. For instance, it is known to group patients according to disease state on particular floors of a hospital, such that cardiac step-down patients are treated on one floor while stroke or neurological patients are treated on a separate floor. This, obviously, allows more convenient staffing assignments based on specialties and experience. Accordingly, one subphase 220 could include floor specific standards of care. Other exemplary subphases could include Intensive Care Unit 230 standards of care, and standards of care related to other types of specific treatment regimens, such as, though not limited to, tobacco cessation 240, DVT prophylaxis 250, or other types of detox treatments or insulin regimens 260. Moreover, disease specific patient care pathways could be viewed as snap-on modules to a general medicine patient care pathway, see e.g. FIG. 4. Architectural decisions will be made through collaborative due process and must abide by the constraints of the operating system and by the guidelines described herein.

### Patient Care Pathway Rapid Design Methodology

Pathway Selection and Assignment Process

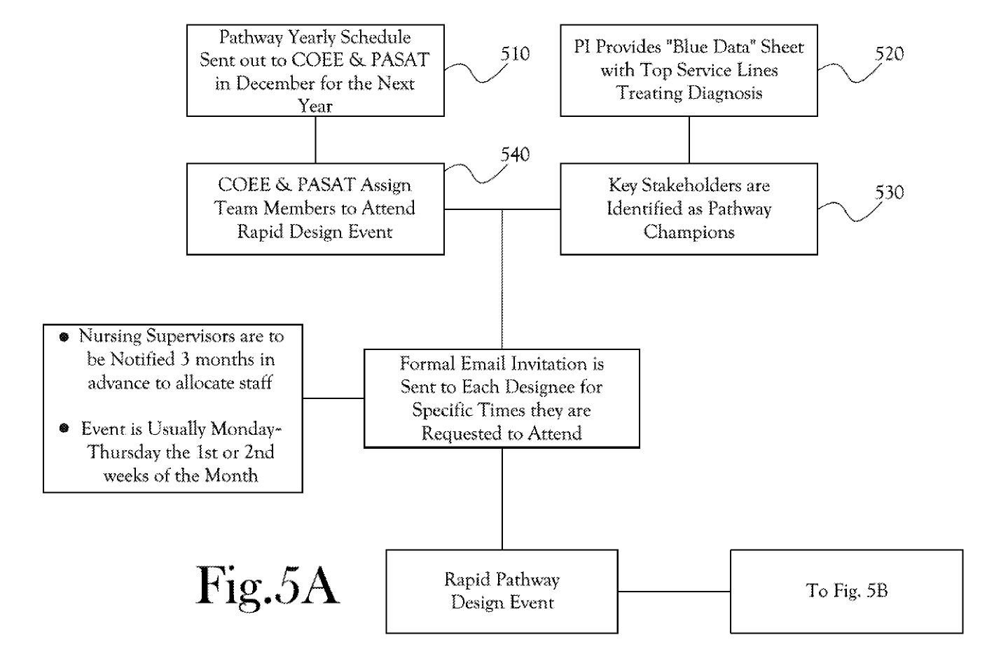

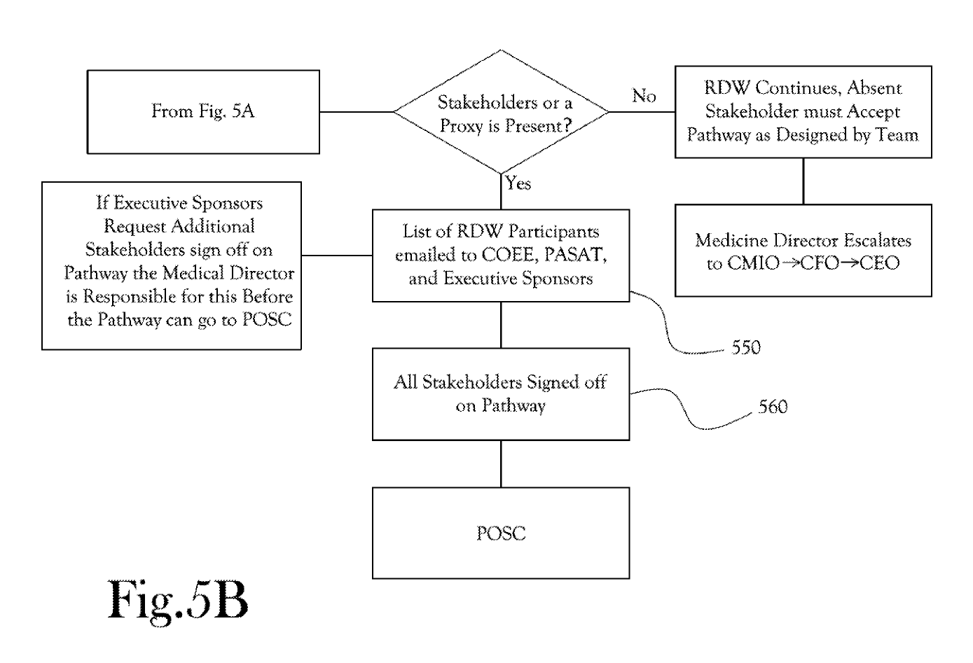

Referring to FIGS. 5A and 5B, the present general inventive concept provides for processes for the decision process for designing, selecting, approving and assigning standardized patient care pathways. In this regard, the decision making process for disease specific pathways is a multi-step process:

1. Pathway requests are submitted to a hospital's Pathway Department by various hospital stakeholders including:
Individual Providers
COEE
Administrators
Regulatory/Payor Demands

2. Performance Improvement provides pertinent outcomes and regulatory data to allow prioritization 520;

3. A hospital's Pathway Medical Director prioritizes next year's pathway 510 schedule based upon considerations which include, but are not limited to, Patient Safety; Patient Volume; LOS; M&M, i.e. morbidity and mortality; Readmissions; Hospital acquired complication rates; Clinical need; Provider demand/efficiency; Responsible resource utilization (cost); Regulatory requirements; Insurance requirements; Institutional strategic initiatives.

4. Performance Improvement identifies key stakeholders 530 by specialty line for each disease state using admission, discharge and procedural data. And, COEE & PASAT assign team members to attend the Rapid Design Event 540.

5. A multi-disciplinary approach is required to approve the list of next pathways. The Medical Director submits the tentative list to the stakeholders, COEE, Executive Sponsors, Senior VP's and CEO for review 550 prior to final approval by the Pathways Reporting Meeting, PAC and MEC.

6. After approval is gained 560, changes are, in accordance with this exemplary embodiment, submitted using the approved change management tool.

Process for PreSearch Packet

In accordance with the present general inventive concept, the objective of the PreSearch packet is to capture outcomes data, evidence based research, patient satisfaction indices, admission/discharge data, regulatory standards, HAC, resource utilization/cost, coding criteria and organizational policies/procedures prior to the event.

In an exemplary embodiment, the PreSearch team includes, but is not limited to, the Revenue Cycle Audit Coordinator; Director for CQO; Medical Director of Clinical Integration; Patient Safety & Accreditation Coordinator; Director of Library Services; Medical Records Coordinator-Coding Analyst; PI Manager; and the VP of UHS Administration.

In an exemplary embodiment, two months prior to the Rapid Design Session, the PFC will send out the PreSearch packet electronically to the PreSearch team to gather pertinent information for the pathway. The PreSearch team will submit their portions back to the PFC within 30 days. The COEE will have 30 days to review the packet prior to their Rapid Design Event. It will be understood, and appreciated, by those skilled in the art that these time frames are exemplary and are not intended to limit the scope of the present general inventive concept.

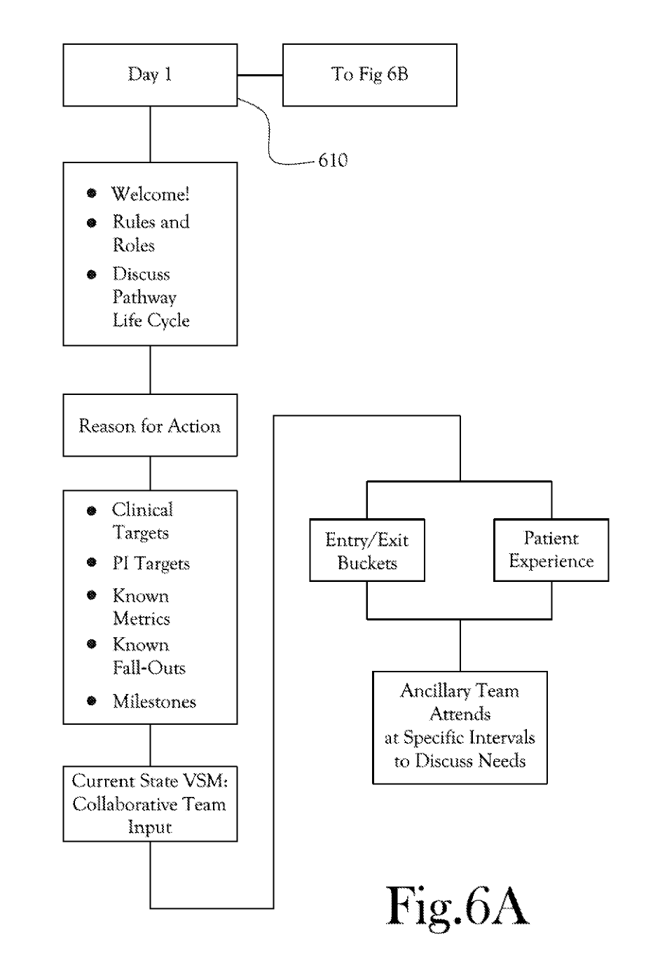

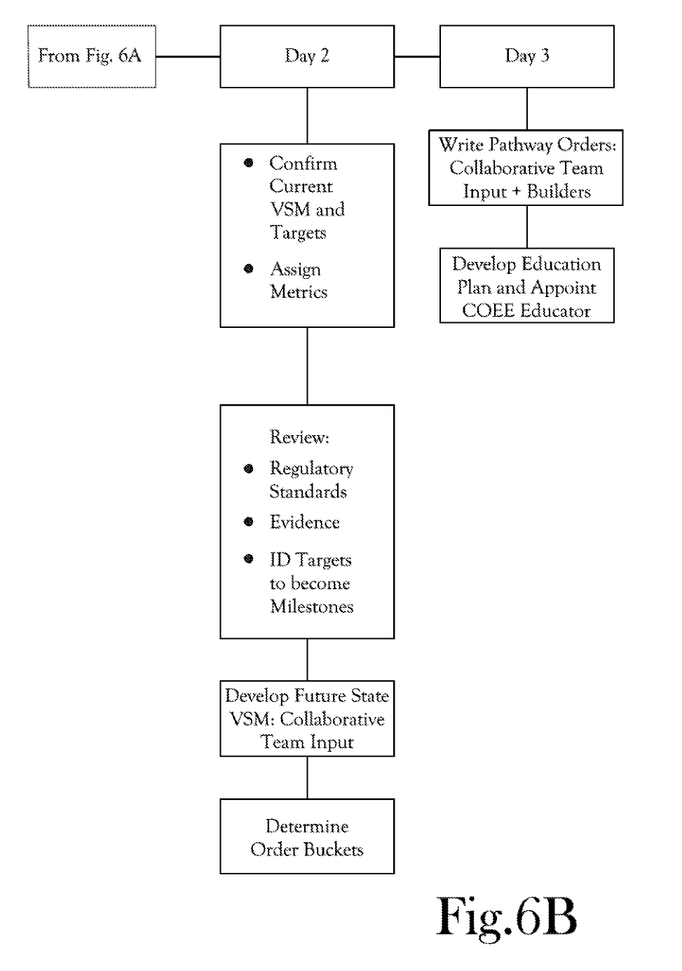

The Rapid Design Session is illustrated diagrammatically in FIGS. 6A and 6B, for a pathway. In an exemplary embodiment, the decision process for Rapid Pathway Build and Review of standardized patient care pathways includes, but is not limited to, the following steps:
1. Builders will build pathways “As Designed”;
2. Pathway builders will attend RDW session as availability allows, preferably with attendance beginning at Day 1 610;
3. Pathway builders will build pathway in Build domain concurrently with the design process;
4. If Pathway builder unable to attend, Medical Director or PFC will document pathway entitled “As Designed”. Copies of the pathway, whether printed in paper format or digitized in electronic format, will be forwarded to build team; and

Prior to team review, pathway builders, PFC and Medical director will review the pathway “As Built” in the Build environment to confirm accuracy of design and resolve outstanding issues which may include follow-up items that require the Pathway team to search for conclusions; the need to discuss the pathways with providers; and searching various evidence based resources.

In an exemplary embodiment, upon completion of this process, at least one final review session is set up for the RDW team to beta test and review the proposed patient care pathway. In an exemplary embodiment, this review session follows at least the following steps:
1. Attendees include: Pathway Team, Multidisciplinary Team and Build Team;
2. Prior to review session, a printout copy of the “As Built” pathway is emailed to the RDW team for preliminary review;
3. Every attempt will be made to complete modification requests prior to review session;
4. “As Built” pathways are projected for team review;
5. Copies of “As Built” pathways are available;
6. The Build domain will be available at the time of review for those who wish to “test-drive” the pathway;
7. Every attempt will be made to modify the pathway in the Build environment during the review session; and
8. Once the modifications from the review session are complete, in the present exemplary embodiment, no further adjustments will be made until reviewed by Pathway Order Set Committee.

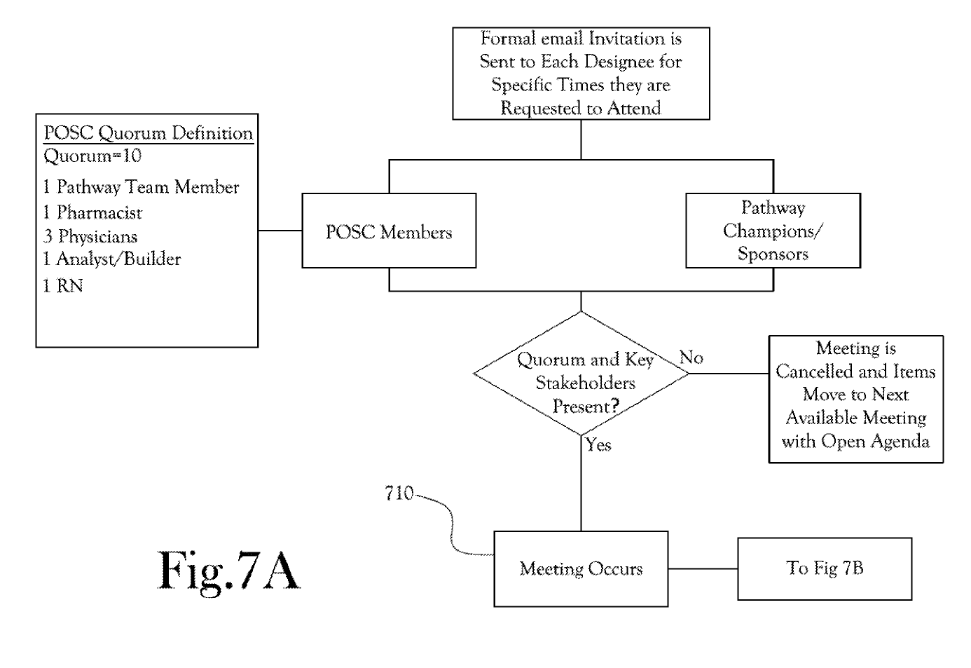

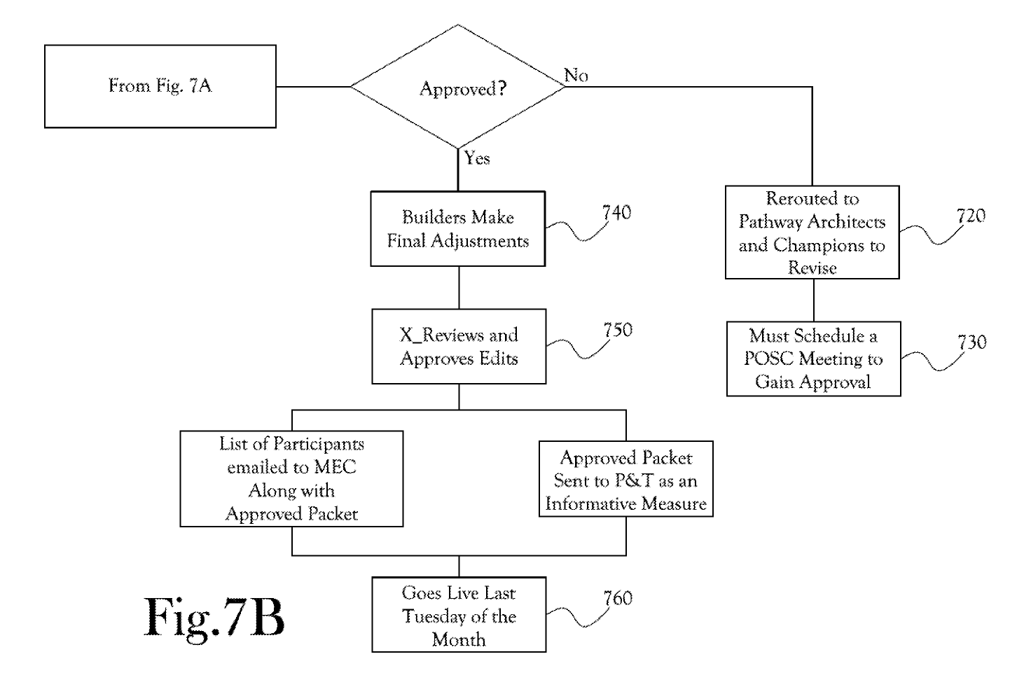

According to the present general inventive concept, and referencing FIGS. 7A and 7B, the designed, reviewed, and tested proposed patient care pathway is subjected to committee approval. In this regard, according to at least one exemplary embodiment, a Pathway Order Set Committee, (“POSC”), meets with a Physician Champion or designee, a Medical Director, and the Pathway Facilitiation Coordinator, (“PFC”), for the purpose of gaining approval for the pathway 710. The process and decision points from one exemplary embodiment of the present general inventive concept for obtaining committee approval are set forth in the flow diagram illustrated at FIG. 7. In this regard, if approval is withheld, the Pathway is returned to the architects and champions for revision 720; and the revised pathway is resubmitted for approval 730. If the pathway is revised, either initially or as revised, any necessary final adjustments are made 740, the pathway is reviewed and edited by a designated individual 750; and the pathway is scheduled to be adopted, i.e. to “go live” 760.

### Patient Care Pathways Education Dissemination Plan

Process for Education and Communication

It will be recognized by those skilled in the art that upon design and ultimate approval of the standardized patient care pathway, the pathway must be communicated to the healthcare provider(s) and the healthcare provider(s) educated regarding the pathway. In one exemplary embodiment of the present inventive concept, the plan for communicating and educating the healthcare provider(s) as to the standardized patient care pathway is actualized by the following entities, listed in an exemplary order of responsibility:

1. COEE appointed educator;

### 2. Pathway Team; and

3. CPOE educator.

The objectives of the plan are to standardize the timing of pathway communications to the consumer; to standardize the content of pathway communications; and to standardize the methods and strategies of pathway communications. Further, depending upon the needs of a given hospital, the content of the patient care pathway must be disseminated and moved into production. It will be appreciated by those skilled in the art, that the Patient Care Pathways of the present invention will, in an exemplary embodiment, be stored, communicated, accessed, implemented, and executed with the assistance of a data processing system which may include hardware and software. In an exemplary embodiment of the present general inventive concept, the following represents one method for moving the content of the pathway into production at a care facility such as a hospital. In this regard, the content will be:
Moved into Production on the last Tuesday of the month;
Summarized by the pathways team and delivered to the CPOE educators on the third Monday of the month preceding release;
Will be summarized into bulleted key points by the pathways team unless the content is of complex design or bears a significant patient safety risk;
Complex pathways will be presented by the pathways team with detailed instructions and screen images; and
Workflow diagrams will be provided by the pathways team.

### Process for Pathway Go-Live

In one exemplary embodiment, and based upon the scheduling parameters of a given care facility and on the schedule of communicating and delivering the pathway discussed herein, an approved pathway will Go-Live the last Tuesday of the month following MEC approval. In an exemplary embodiment, an electronic announcement on a computer device will precede Go-Live as a reminder; and text page reminders will be sent out the day of Go-Live to applicable service lines. Once an approved pathway goes live, a patient is treated in accordance with the parameters of the pathway. It will be appreciated by those skilled in the art, that during a course of treatment, a patient may be treated in accordance with multiple pathways. In this regard, the patient is admitted, assigned to a floor based upon the type of care required by the patient. The patient may be treated according to multiple pathways, including general medicine standards of care and disease specific standards of care. Metrics such as the patient's vital signs will be measured and assessed according to the various pathways applicable to the patient, and the patient is treated according to the pathways applicable to the patient.

### Process for Pathway Compliance Metrics

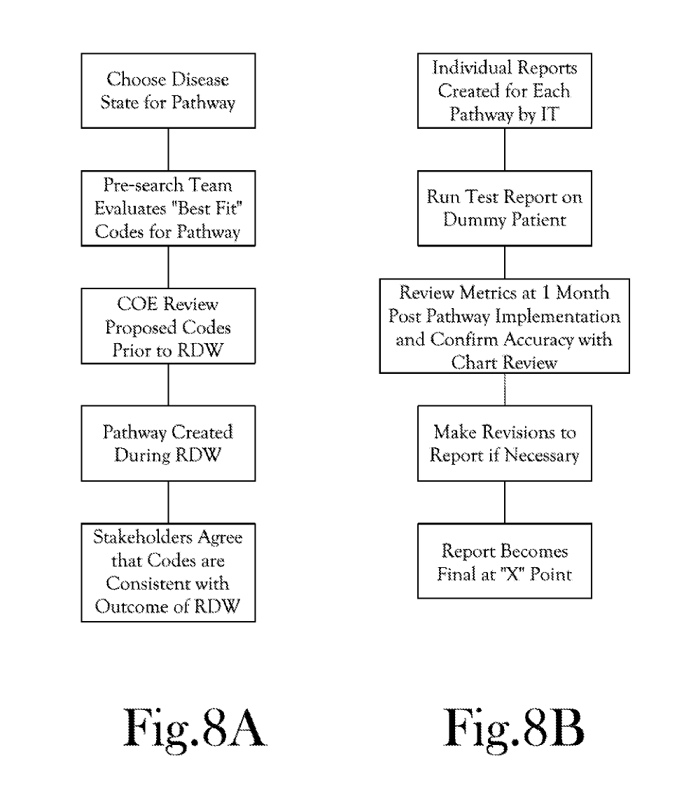

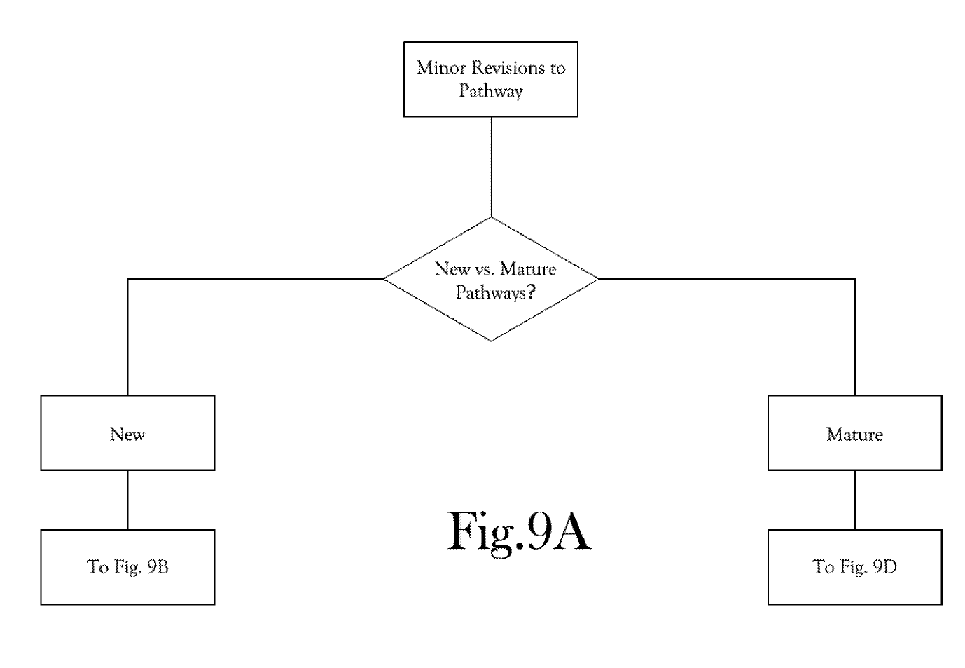

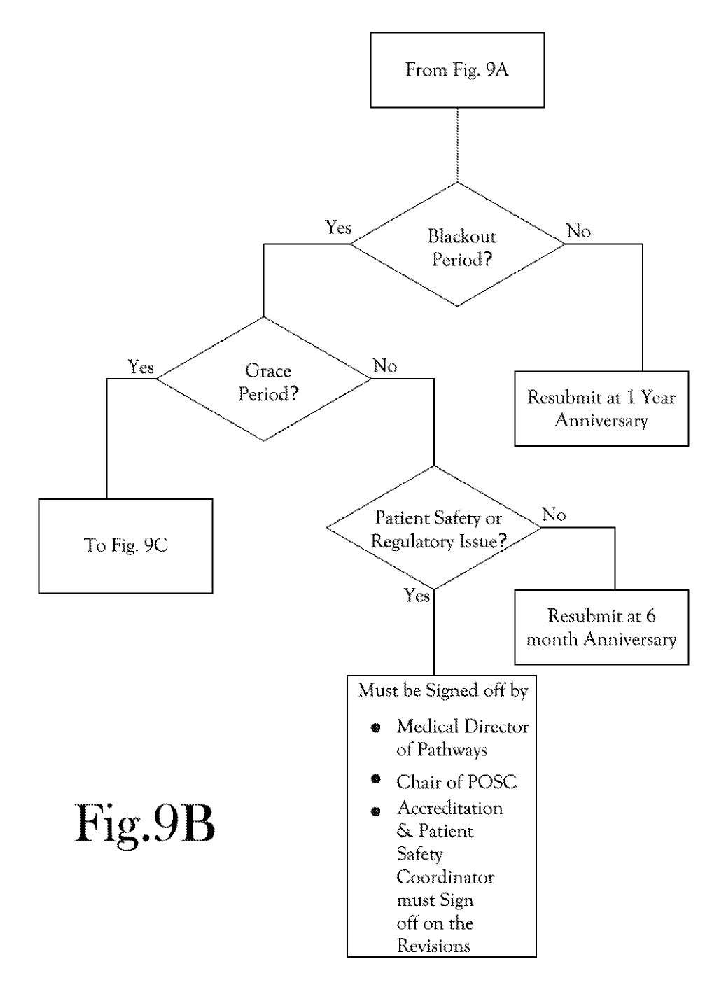

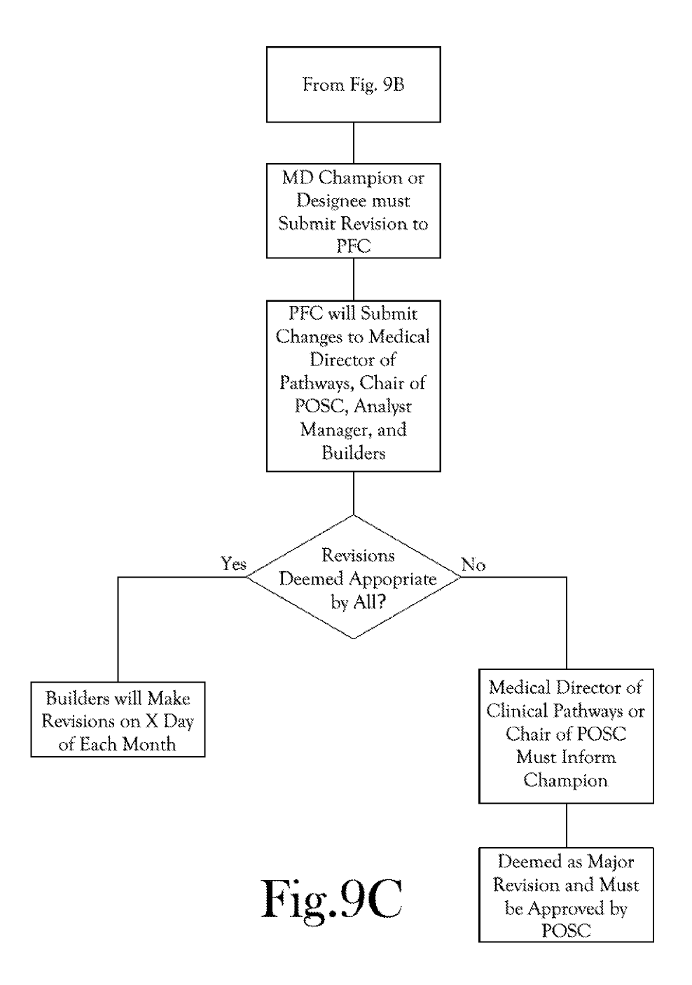

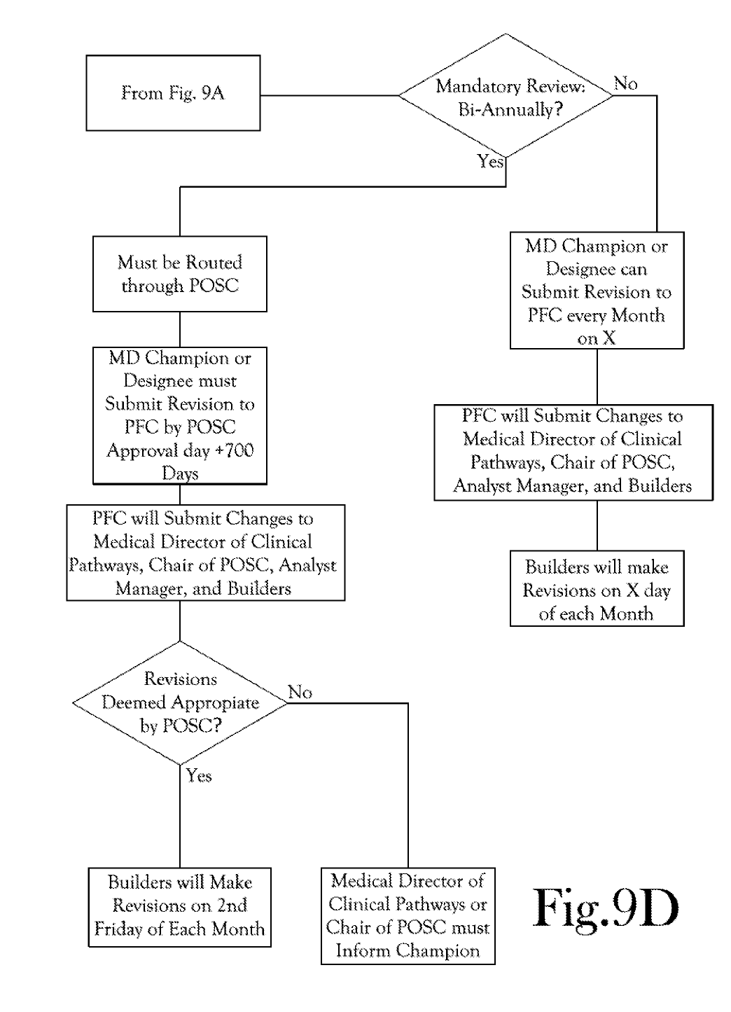

In an exemplary embodiment, Reportable data is on a two month delay from the pathway Go-Live date. The compliance metrics are to be disseminated to the stakeholders at the Pathway Reporting Meeting or via email. The exemplary embodiment of the schedule for designing, building, submitting for approval, and generating the compliance metrics discussed herein is summarized in FIGS. 8A and 8B. Further, an exemplary process and decision point matrix for making both minor and major revisions to a pathway is illustrated in the flow chart illustrated in FIGS. 9A, 9B, 9C, and 9D. In this regard, the process for revising a new pathway is set forth in FIGS. 9B and 9C, while the process for revising a mature pathway is illustrated in FIG. 9D.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A process for devising, disseminating, communicating, utilizing, and monitoring standardized patient care pathways in a medical care facility for treatment of a patient whereby standardized patient care pathways are developed in a time and resource efficient manner, said process comprising the steps:
developing key markers in the delivery of care to the patient that identify progression to wellness, whereby said key markers define milestones that identify steps in a patient's progression to wellness;
submitting a pathway request to a care facility's pathway department that includes said key markers;
building a proposed pathway based upon standards of care, wherein said pathway includes said key markers and is also based on parameters in said pathway request;
obtaining approval of said proposed standardized patient care pathway;
communicating an approved patient care pathway to a healthcare provider;
monitoring the implementation and execution of said patient care pathway, wherein said steps of communicating an approved patient care pathway and monitoring the implementation and execution of said patient care pathway is done with the assistance of a data processing system; and
treating a patient in accordance with at least one said approved patient care pathway, whereby metrics such as said patient's vital signs will be measured and assessed according to said at least one approved patient care pathway.

2. The process for devising, disseminating, communicating, utilizing, and monitoring standardized patient care pathways in a medical care facility for treatment of a patient of claim 1 wherein said standardized patient care pathways are developed through multi-disciplinary collaborative process and are based on accepted practices for standard of care.

3. The process for devising, disseminating, communicating, utilizing, and monitoring standardized patient care pathways in a medical care facility for treatment of a patient of claim 1 whereby said care facility's pathway department includes at least one multi-disciplinary healthcare team organized for the purpose of collaborating to discuss standard of care for a specific disease state.

4. The process for devising, disseminating, communicating, utilizing, and monitoring standardized patient care pathways in a medical care facility for treatment of a patient of claim 1 wherein said standardized patient care pathways include treatment regimens for medical procedures from a group consisting of unit standards, pain management plans, complex drip protocols, common bedside procedures, DVT prophylaxis, and tobacco cessation, and drug detoxification plans.

5. The process for devising, disseminating, communicating, utilizing, and monitoring standardized patient care pathways in a medical care facility for treatment of a patient of claim 1 wherein said standardized patient care pathway is a general admission pathway comprising non-disease specific orders pertaining to admission procedures for patients of said medical care facility, whereby common orders are bundled together in a manner that avoids duplication in instances where multiple disease specific snap-ons are required to complete the continuum of care for the patient.

6. The process for devising, disseminating, communicating, utilizing, and monitoring standardized patient care pathways in a medical care facility for treatment of a patient of claim 1 wherein said standardize patient care pathway is a disease specific pathway comprising a bundled set of orders that outline a plan of care for a specific disease state.

7. The process for devising, disseminating, communicating, utilizing, and monitoring standardized patient care pathways in a medical care facility for treatment of a patient of claim 5 wherein in said general admission pathway further comprises a disease specific pathway comprising a bundled set of orders that outline a plan of care for a specific disease state.

8. The process for devising, disseminating, communicating, utilizing, and monitoring standardized patient care pathways in a medical care facility for treatment of a patient of claim 1 wherein said standardized patient care pathways contain standards of care from a group consisting of pre-operative standards, post-operative standards, standards of care for designated post-operative days, and standards of care for patient discharge.

9. The process for devising, disseminating, communicating, utilizing, and monitoring standardized patient care pathways in a medical care facility for treatment of a patient of claim 1 whereby by approval said proposed patient care pathway is accomplished by a pathway order set committee including at least a physician champion, a medical director for said care facility, and a pathway facilitation coordinator.

10. The process for devising, disseminating, communicating, utilizing, and monitoring standardized patient care pathways in a medical care facility for treatment of a patient of claim 1 whereby by said process further includes the step of educating said healthcare provider regarding said approved patient care pathway and said step of educating said healthcare provider regarding said approved patient care pathway follows said step of communicating an approved patient care pathway to a healthcare provider.

11. The process for devising, disseminating, communicating, utilizing, and monitoring standardized patient care pathways in a medical care facility for treatment of a patient of claim 1 whereby said step of building said proposed pathway based upon standards of care, wherein said pathway includes said key markers and is also based on parameters in said pathway request is done collaboratively.

12. A process for devising, disseminating, communicating, utilizing, and monitoring standardized patient care pathways in a medical care facility for treatment of a patient whereby standardized patient care pathways are developed in a time and resource efficient manner, said process comprising the steps:
developing key markers in the delivery of care to the patient that identify progression to wellness, whereby said key markers define milestones that identify steps in a patient's progression to wellness;
submitting a pathway request to a care facility's pathway department that includes said key markers;
collaboratively building a proposed pathway based upon standards of care, wherein said pathway includes said key markers and is also based on parameters in said pathway request;
obtaining approval of said proposed standardized patient care pathway, whereby approving said proposed standardized patient care pathway is accomplished collaboratively;
communicating an approved patient care pathway to a healthcare provider;
educating said healthcare provider regarding said approved patient care pathway;
monitoring the implementation and execution of said patient care pathway, wherein said steps of communicating an approved patient care pathway and monitoring the implementation and execution of said patient care pathway is done with the assistance of a data processing system; and
treating a patient in accordance with at least one said approved patient care pathway, whereby metrics such as said patient's vital signs will be measured and assessed according to said at least one approved patient care pathway.

13. The process for devising, disseminating, communicating, utilizing, and monitoring standardized patient care pathways in a medical care facility for treatment of a patient of claim 12 wherein said standardized patient care pathways are developed through multi-disciplinary collaborative process and are based on accepted practices for standard of care.

14. The process for devising, disseminating, communicating, utilizing, and monitoring standardized patient care pathways in a medical care facility for treatment of a patient of claim 12 whereby said care facility's pathway department includes at least one multi-disciplinary healthcare team organized for the purpose of collaborating to discuss standard of care for a specific disease state.

15. The process for devising, disseminating, communicating, utilizing, and monitoring standardized patient care pathways in a medical care facility for treatment of a patient of claim 12 wherein said standardized patient care pathways include treatment regimens for medical procedures from a group consisting of unit standards, pain management plans, complex drip protocols, common bedside procedures, DVT prophylaxis, and tobacco cessation, and drug detoxification plans.

16. The process for devising, disseminating, communicating, utilizing, and monitoring standardized patient care pathways in a medical care facility for treatment of a patient of claim 12 wherein said standardized patient care pathway is a general admission pathway comprising non-disease specific orders pertaining to admission procedures for patients of said medical care facility, whereby common orders are bundled together in a manner that avoids duplication in instances where multiple disease specific snap-ons are required to complete the continuum of care for the patient.

17. The process for devising, disseminating, communicating, utilizing, and monitoring standardized patient care pathways in a medical care facility for treatment of a patient of claim 12 wherein said standardize patient care pathway is a disease specific pathway comprising a bundled set of orders that outline a plan of care for a specific disease state.

18. The process for devising, disseminating, communicating, utilizing, and monitoring standardized patient care pathways in a medical care facility for treatment of a patient of claim 16 wherein in said general admission pathway further comprises a disease specific pathway comprising a bundled set of orders that outline a plan of care for a specific disease state.

19. The process for devising, disseminating, communicating, utilizing, and monitoring standardized patient care pathways in a medical care facility for treatment of a patient of claim 12 wherein said standardized patient care pathways contain standards of care from a group consisting of pre-operative standards, post-operative standards, standards of care for designated post-operative days, and standards of care for patient discharge.

20. The process for devising, disseminating, communicating, utilizing, and monitoring standardized patient care pathways in a medical care facility for treatment of a patient of claim 12 whereby by said step of collaboratively approving said proposed patient care pathway is accomplished by a pathway order set committee meeting with at least a physician champion, a medical director for said care facility, and a pathway facilitation coordinator.
